(19) United States
(12) Patent Application Publication
(10) Pub. No.: US 2021/0381311 A1
(43) Pub. Date: Dec. 9, 2021

(54) Apparatus and Method for Stabilizing a Ladder

(71) Applicant: Fritz Bjørnevaag, Stavanger (NO)

(72) Inventor: Fritz Bjørnevaag, Stavanger (NO)

(21) Appl. No.: 16/461,990

(22) PCT Filed: Nov. 24, 2017
(86) PCT No.: PCT/IB2017/001744

§ 371 Date: May 17, 2019

(30) Foreign Application Priority Data
Nov. 23, 2016 (NO) 20161863

(51) Int. Cl. E06C 7/06; E06C 7/18; E06C 7/48; E06C 7/46

(52) U.S. Cl. CPC E06C 7/06; E06C 7/188; E06C 7/186; E06C 7/46; E06C 7/48

(57) ABSTRACT

A device is for securing a ladder against falling to one side. The device has a first reel and a second reel. The first reel has a first elongated, flexible connecting means arranged to be run to an anchor via one end portion of the ladder. The second reel has a second elongated, flexible connecting means arranged to be run to an anchor via the second end portion of the ladder. A locking mechanism is for locking the elongated flexible connecting means. The device is mountable on the ladder in such a way that, in a position of use, the locking mechanism is accessible from one end portion of the ladder. A ladder mounted with the device and a method is for securing the ladder against falling to one side.

The invention relates to a device for securing a ladder against falling to one side, and a ladder to which the device has been fitted. In addition, the invention relates to a system and a method for securing a ladder against falling to one side.

There are several fall accidents with the use of ladders. There may be several causes; it may be slippery or the ladder may be placed incorrectly against a wall or the like. The ladder may then slide down, or fall forwards, backwards or sideways. This is a known problem, and various solutions have been invented to solve it.

In the patent with the number GB 2432621 A, a ladder which is secured to a wall by means of a rope reel and a rope on each side is disclosed. With this solution, the ladder may fall sideways by too much weight on one side up in the ladder. The patent with the number GB 2069579A discloses a ladder with ropes in V-shapes out from the ladder sides. The ropes are slidingly attached through snap hooks which, in their turn, are attached to eye bolts on a wall. It has turned out in trials that the ladder will fall sideways by too much weight on one side, because the ropes will slide through the snap hooks on both sides. GB 2428730 discloses a ladder with four lockable, automatic-rewind rope reels, wherein two rope reels are placed in the lower part of the ladder and two rope reels are placed in the upper part of the ladder. The ropes may be pulled out and secured to an anchor, which is mounted to a building, for example. By locking the rope reels, so that the rope cannot be pulled further out, the ladder will be secured both at the upper part and at the lower part and will thus be secured against falls in all directions. A drawback of this system is that, to stabilize the ladder, it is necessary to climb up the ladder before it has been stabilized, in order to lock the upper rope reels. Thereby the ladder may fall the first time it is used. If a ladder is not stably positioned, it will often fall the first time it is climbed.

The invention has for its object to remedy or reduce at least one of the drawbacks of the prior art or at least provide a useful alternative to the prior art. The object is achieved through the features that are specified in the description below and in the claims that follow. The invention is defined by the independent claims. The dependent claims define advantageous embodiments of the invention.

In a first aspect, the invention relates more specifically to a device for securing a ladder against falling to one side, the device including:
a first reel and a second reel, the first reel including a first elongated, flexible connecting means arranged to be run to an anchor via one end portion of the ladder, and the second reel including a second elongated, flexible connecting means arranged to be run to an anchor via the second end portion of the ladder; and
a locking mechanism for locking the elongated, flexible connecting means;

the device being mountable to the ladder so that, in a position of use, the locking means will be accessible from one end portion of the ladder.

The elongated, flexible connecting means may be, for example, ropes, belts, chains or any other connecting means which lends itself to being reeled on a reel. To facilitate reading of the description, the word rope is used for an elongated, flexible connecting means in this description. The reels may be automatic-rewind reels.

A ladder may be secured against falling to one side by the device being fitted to the ladder. A ladder comprises two lateral uprights and a plurality of rungs connecting the two lateral uprights. The first rope is run via one end portion of the ladder to a first anchor away from the ladder, and the second rope is run via the second end portion to a second anchor away from the ladder, after which the ropes are locked by means of the locking mechanism. In an alternative embodiment, both the first rope and the second rope may be run to the same anchor away from the ladder.

If the ladder has hollow rungs, the ropes may each be run through a respective hollow rung at a respective end portion of the ladder. Alternatively, the ropes may be run around the upright at the respective end portions. The most important aspect is that the ropes are run via both end portions of the ladder to stabilize the ladder at the end portions. If the ladder is only stabilized at a single portion, it may rotate around this portion and thereby fall.

The ropes may be secured, for example, to a wall by means of eye bolts that have been screwed into the wall, to windows or other smooth surfaces by means of suction cups, or around trees or pillars. When the ropes have been run via the two end portions of the ladder and have been locked, the ladder cannot fall laterally, neither at the top nor at the base. The device can be fitted in such a way that the locking mechanism is accessible from one end portion of the ladder, whereby the ladder can be secured against falling to one side by the ropes being locked before the user steps onto the ladder for the first time. The problem of an unstably placed ladder possibly falling the first time it is used is thereby solved by the invention.

By fitting two devices to the ladder, this can be secured against falling in any direction whatsoever, and against the lower end portion of the ladder sliding out. The two ropes from one device can thereby each be run via a respective end portion of one ladder upright to an anchor at a distance from the ladder on one side of the ladder, possibly via the same snap hook, whereas the two ropes from the other device may be run via respective end portions of the other ladder upright to an anchor at a distance from the ladder on the other side of the ladder. Both end portions may thereby be secured against falls to both sides, which means that the ladder is secured against falling. If the devices are fitted in such a way to the ladder that both locking mechanisms are accessible from one end portion, and the orientation of the ladder is such that this one end portion is the lower end portion, the ropes can be locked and the ladder thereby secured against falling before the user steps onto the ladder for the first time.

The device can be fitted anywhere on the ladder, but, preferably, it may be fitted to the external side of the ladder upright of a ladder, so that it will not be in the way during use of the ladder. The device may be mountable, for example, by including holes or fittings with holes, through which screws or the like may be passed. If the ladder is made of wood, the screws may be screwed directly into the wood. If the ladder has hollow rungs, the device may, for example, be fitted by means of at least one rod with a stop nut at one end and threads at the other end and a corresponding sleeve with a stop nut at one end and internal threads at the other end. The rod may be passed through the hole of the device or fitting and into a hollow rung from one side, whereas the sleeve is passed through the hollow rung from the other side, after which the rod and sleeve are screwed together. Possibly, an extra fitting is included on the opposite ladder upright if the hole of the hollow rung is larger than the stop nut. This fitting method has the advantage of lending itself to ladders with different distances between the ladder uprights.

If it is desirable that two devices according to the invention should be fitted to a ladder, these two may be fitted to separate ladder uprights, by the rod with threads and stop nut being inserted through the hole of one device and into the hollow rung from one ladder upright, whereas the sleeve with stop nut and internal threads is inserted through the hole of the other device and into the hollow rung from the other ladder upright. This is a simple way in which two devices can be fitted.

In one embodiment, both ropes of the device can be locked by the same locking mechanism, and in another embodiment, the device may be provided with one locking mechanism for each rope. With only one locking mechanism for locking both ropes, the device may be easier to manufacture, and may make a ladder with the device fitted quicker to put up or move.

Both reels with ropes may be placed within the same housing, which may facilitate the handling of the device and the fitting of the device to a ladder. The device may be formed from plastic, metal or other suitable material.

The first rope and the second rope may each be provided with a free end. The free ends of the ropes may be arranged to be attached to a fastening device, for example by means of ring terminations. This may facilitate the attaching of the ropes. For example, both ropes from the device may be attached to the same snap hook, which may facilitate the stabilizing of the ladder. Thereby the user may pull both ropes out in a V-shape by pulling on the snap hook and securing this to an anchor away from the ladder. Automatic-rewind reels may ensure that the ropes are always tautened.

Two devices may also be arranged in the same housing, which will, in practice, be a double device with four reels and four ropes in the double device. This device can be fitted to one ladder upright, for example. The double device may have one locking mechanism for each rope, two locking mechanisms locking two ropes each, or one locking mechanism locking all four ropes. A double device may be easier to fit to a ladder and to move from one ladder to another ladder.

The locking mechanism may include at least one resilient part and a rough surface, the resilient part being arranged for locking one or both ropes by clamping these against the rough surface. The resilient part may also have a rough surface itself, to increase the friction between the rope and the surface. The locking mechanism may include a locking handle or the like for locking or releasing the ropes.

The device may include a locking bail connected to the locking mechanism, wherein the locking bail may be fitted in such a way that it runs along one of the lower ladder rungs, and so that both ropes are locked when the user steps onto this rung for the first time. Thereby the user does not need to remember to lock the ropes. If two devices are fitted on the same ladder, the locking mechanism of both devices may be connected to the same locking bail, whereby all four ropes can be locked with a single locking bail.

In a second aspect, the invention relates more specifically to a ladder to which at least one device according to the first aspect of the invention has been fitted. Thereby the ladder is at least secured against falling to one side. If two devices are fitted to the ladder, it is secured against falls in all directions. The device or devices may be fitted in such a way that the locking mechanism is accessible from one end portion of the ladder, whereby the ropes can be locked before a user of the ladder steps onto the ladder for the first time. The ladder may include hollow rungs, and the first rope may have been run along one ladder upright of the ladder and through a hollow rung at one end portion of the ladder, and the second rope may have been run along the ladder upright and through a hollow rung at the other end portion of the ladder. If two devices are fitted on separate ladder uprights, both end portions of both ladder uprights may be secured, the ladder thereby being secured against falls in all directions. The ropes may have been threaded through separate hollow rungs to reduce wear on the ropes. The openings of the hollow rungs may also be provided with curved, smooth edges or small rotatable wheels to reduce wear on the ropes. The ropes may also have been run via the end portions of the ladder by means of guiding means, for example eye bolts mounted at the end portions of the ladder. Alternatively, the ropes may have been run around separate end portions of the ladder upright.

In a third aspect, the invention relates to a system for stabilizing the ladder according to the second aspect of the invention, the system further including anchoring devices which can be secured to a surface and which can receive the ends of the ropes. These anchoring devices may, for example, be eye bolts for screwing into a wall or the like, or carrier suction cups to be stuck onto windows or smooth surfaces.

In a fourth aspect, the invention relates to a method for stabilizing the ladder according to the second aspect, the method comprising the steps of:
pulling the ropes out from the rope drums;
securing the snap hooks to an anchor away from the ladder; and
locking the ropes by means of the locking mechanism.

In a fifth aspect, the invention relates to a device for securing a ladder against falling to one side, the device being adapted for letting out two ropes and locking these ropes, and the device being mountable to a ladder.

A second device for securing a ladder against falling to one side is described as well, the second device including:
at least one reel;
at least one elongated, flexible connecting means attached to the at least one reel and arranged to be run via the end portions of the ladder to at least one anchor for fixed connection;
at least one locking mechanism for locking the at least one elongated, flexible connecting means;

the device being mountable to the ladder in such a way that, in a position of use, the at least one locking mechanism is accessible from one end portion of the ladder. This second device solves the same problems as the device according to the first aspect of the invention by being able to secure a ladder against falling to one side before a user steps onto the ladder for the first time, but it includes additional embodiments.

For example, the second device may comprise two reels and a rope, the reels being connected to separate ends of the same rope, and the rope being arranged to be run via both end portions of the ladder upright, and the rope comprising a fastening mechanism attached to the rope in a position between the reels. Thereby the rope may be pulled out laterally, the fastening mechanism be secured to an anchor, and the rope be locked by means of the locking mechanism before the user steps onto the ladder. Thereby the ladder cannot fall to one side. If two of the second devices are fitted, the ladder cannot fall to any of the sides.

The second device may also include a reel, a rope, and a lockable fastening mechanism which can slide along the rope, but also be locked to a position on the rope. This second device may be fitted to a ladder in such a way that one end of the rope is attached around the reel, whereas the other end of the rope is secured with a fixed connection to, for example, the ladder. The rope may run via the end portions of the ladder upright, for example by the ends of the rope being secured to separate end portions, or by the rope having been run around the ladder upright at both end portions. Between these end portions, there is the lockable fastening mechanism which can slide along the rope. The ladder can be secured against falling to one side by pulling on the lockable fastening mechanism. With this, the reel will let out more rope, and the lockable fastening mechanism will slide along the rope so that the rope runs in a V-shape between the end portions of the ladder upright and the lockable fastening mechanism. The lockable fastening mechanism is secured to an anchor and locked, and the reel is locked before a user steps onto the ladder. With this, the ladder will be secured against falling to one side. If two of the second devices are fitted, the ladder cannot fall to any of the sides.

Also, a device for stabilizing a ladder is described, in which two automatic-rewind rope drums, with two rope reels in each, functioning independently of each other, are fitted to each outer side of the ladder, so that when the ladder is secured to a wall, all four ropes are locked to the rope drums and in eye bolts mounted to a wall, this is to prevent the ladder from falling, characterized by the ropes being run up and down along the sides of the ladder, run through the holes in ladder rungs, two rope ends with ring terminations being attached to a snap hook on each side of the ladder, pulled out in a V-shape and being hooked into the eye bolts on the wall or suction cups fixed to windows, and firmly locked in position by the use of opening and locking handles on the rope drums.

In what follows, examples of preferred embodiments are described, which are visualized in the accompanying drawings, in which:

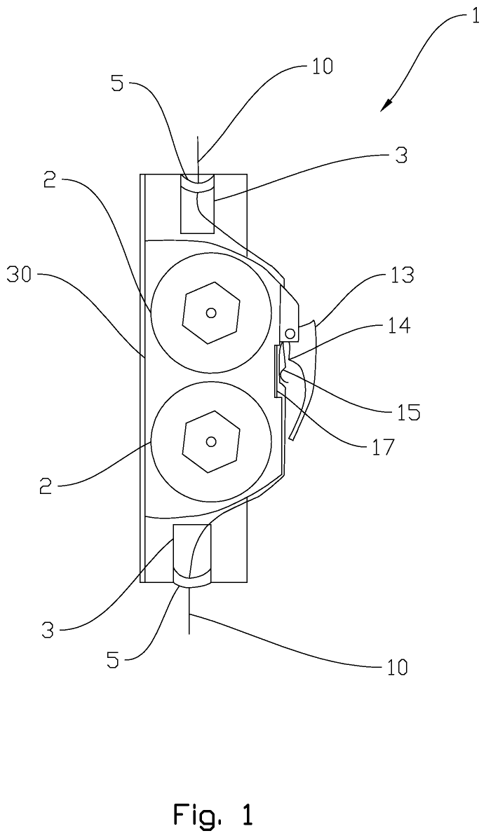

FIG. 1 shows, viewed from the side, a device according to the invention with two reels inside and a locking handle attached to the front of the device in the locked state;

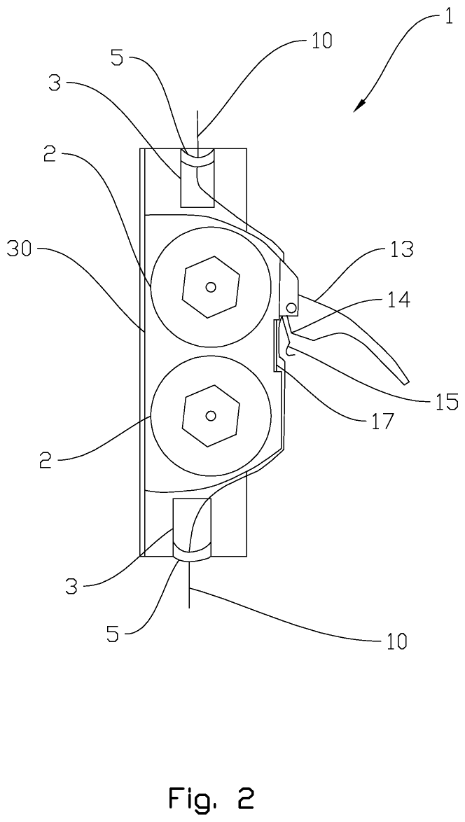

FIG. 2 shows the device of FIG. 1 in the open state;

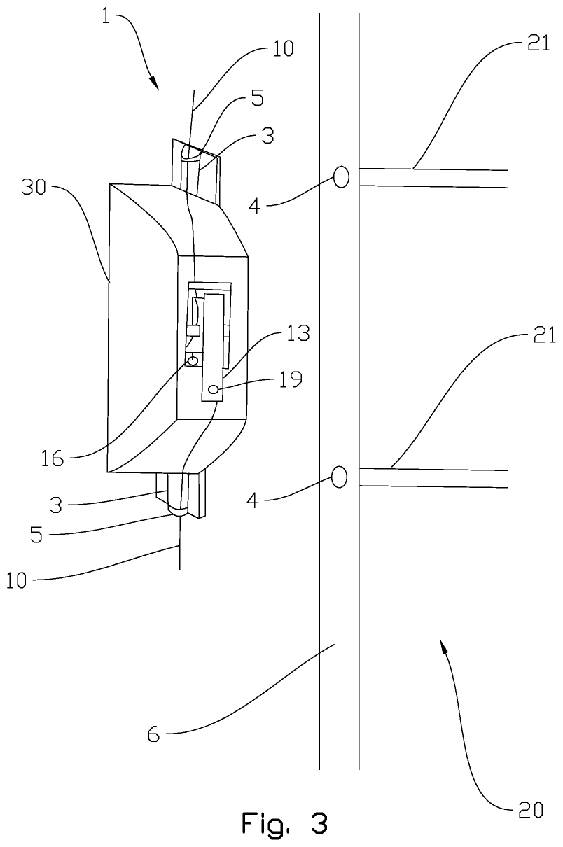

FIG. 3 shows a device according to the invention with a locking handle and elongated attachment holes which may be used in fitting to a ladder, and part of a ladder;

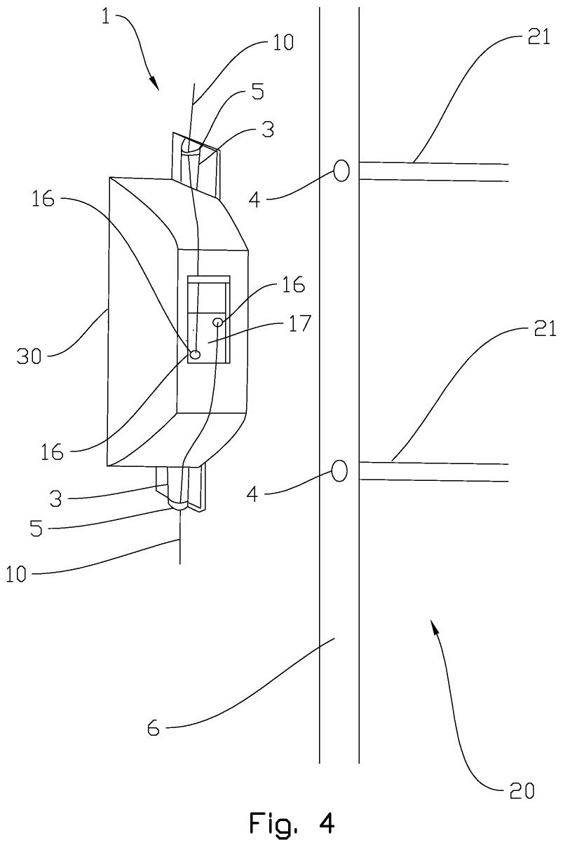

FIG. 4 shows a device according to the invention with two holes for two ropes passing each other in opposite directions, and a recessed rough surface;

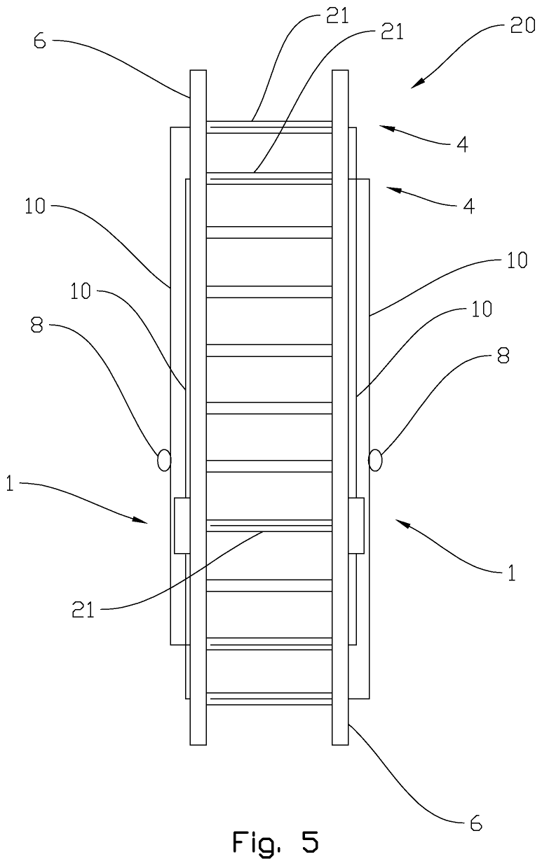

FIG. 5 shows a ladder with devices according to the invention fitted on the outer sides of both ladder uprights, the ropes running through hollow rungs in the ladder;

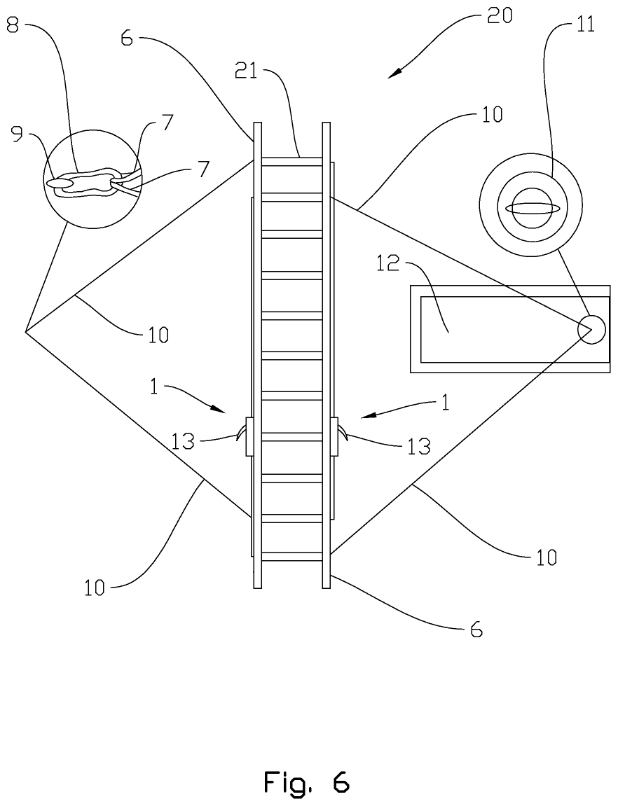

FIG. 6 shows a stabilized ladder in a position of use against a wall;

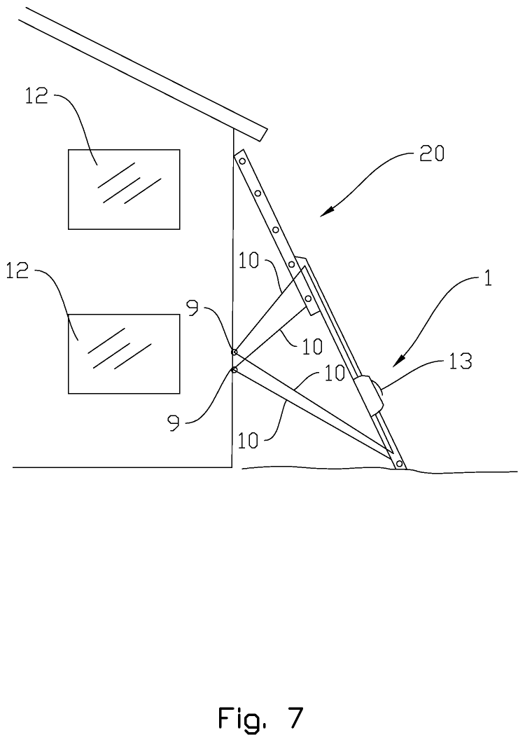

FIG. 7 shows a stabilized extension ladder from the side in a position of use against a wall;

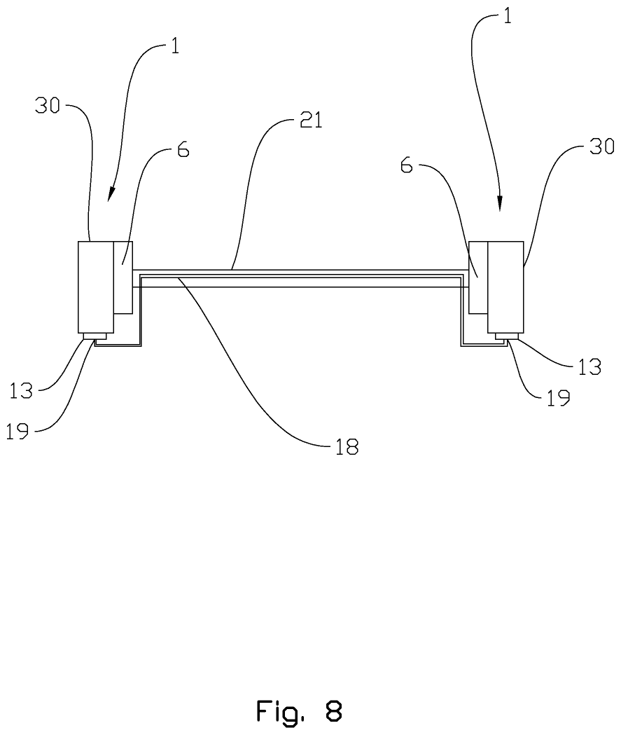

FIG. 8 shows, in a view from above, a cross section of a ladder with devices according to the invention fitted on both ladder uprights, and a longitudinal bail which is attached to the locking handles of the devices;

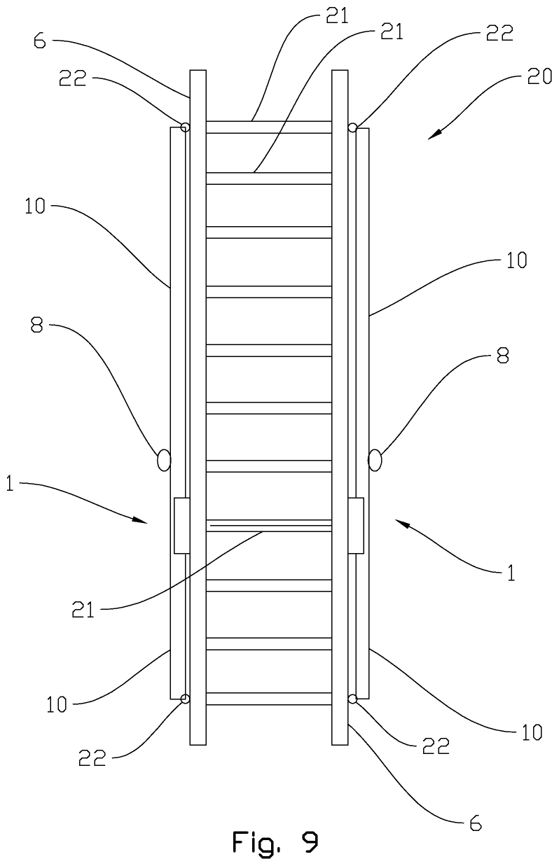

FIG. 9 shows a ladder with devices according to the invention fitted to the outer sides of both ladder uprights, the ropes running through eye bolts on the ladder;

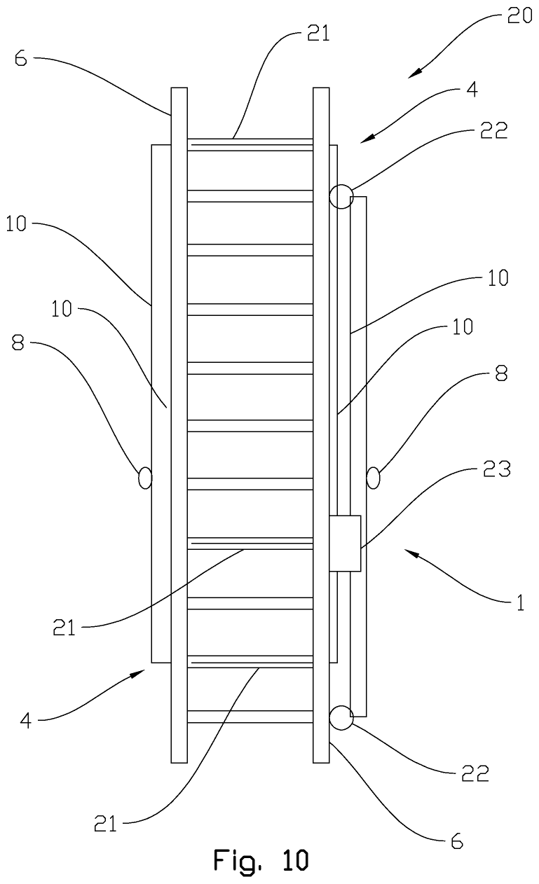

FIG. 10 shows a ladder with two devices fitted to one ladder upright and in the same housing;

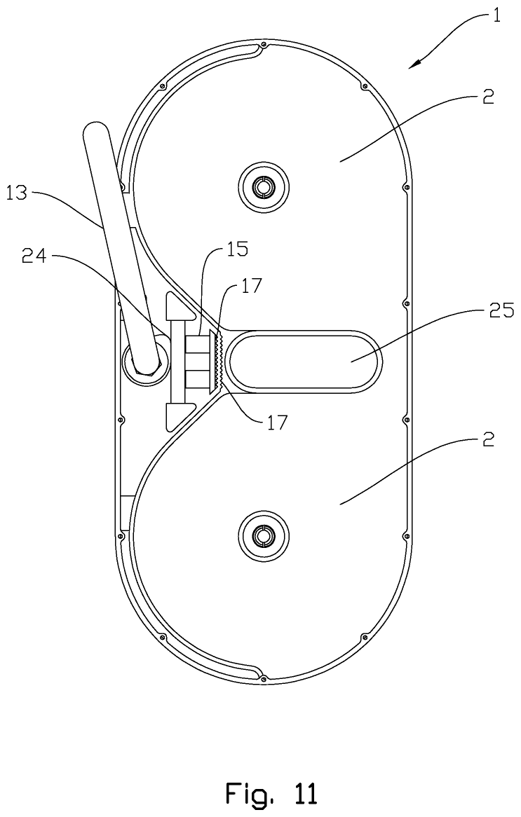

FIG. 11 shows a second embodiment of the device according to the invention, viewed from one side;

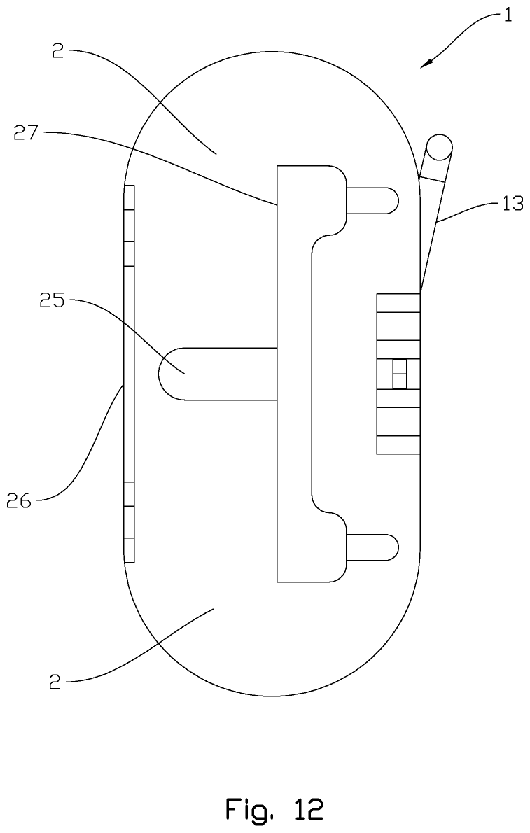

FIG. 12 shows the embodiment of FIG. 11, viewed from the other side;

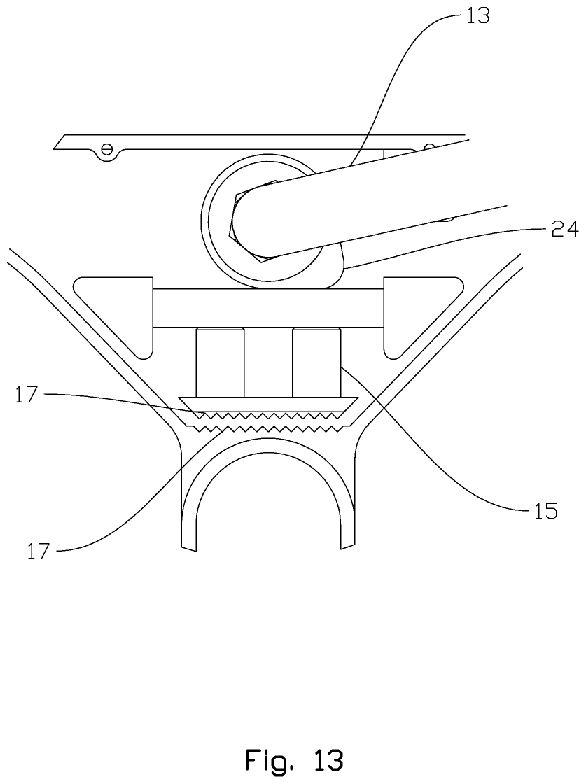

FIG. 13 shows, on a larger scale, the locking mechanism of the embodiment of FIG. 11 in the open state;

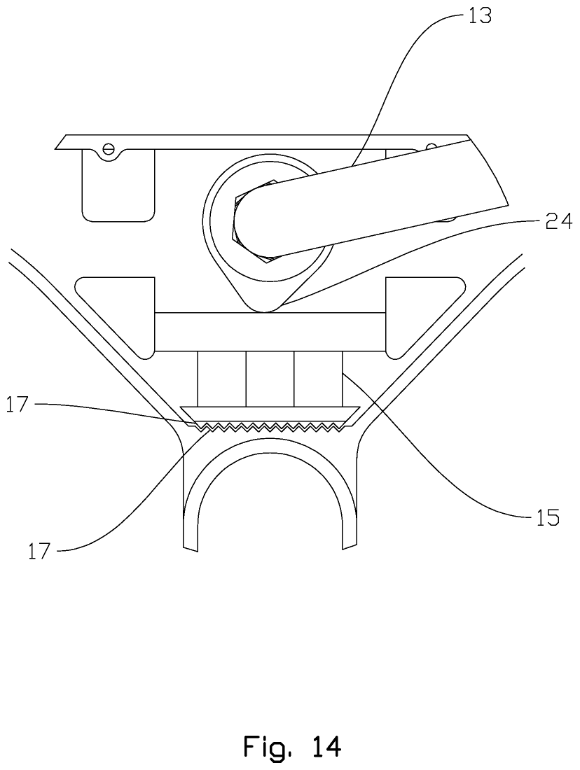

FIG. 14 shows the locking mechanism of FIG. 13 in the locked state; and

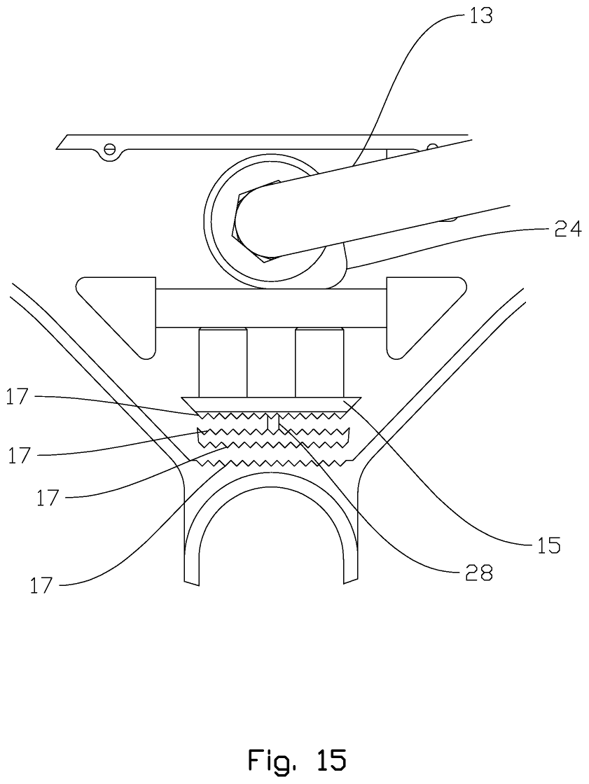

FIG. 15 shows a similar locking mechanism to that of FIGS. 13 and 14, but with two spaces with rough surfaces.

In the figures, the reference numeral 1 indicates a device according to the first aspect of the invention. Like reference numerals indicate like or similar elements in the figures. The drawings are presented in a schematic and simplified form, and different elements are not necessarily to scale.

FIGS. 1 and 2 show, from the side, a device 1 comprising two reels 2 placed in a housing 30. A locking handle 13 is rotatably attached to the front of the housing 30, in the closed (FIG. 1) and open (FIG. 2) states. In the drawings, the housing 30 of the device 1 is shown transparently to show the reels 2. The locking handle 13 works in such a way that a protruding bottom side 14 rests movably against a resilient bail 15. When the locking handle 13 is being depressed, the resilient bail 15 is pressed against the two ropes 10 coming out of the openings 16 (shown in FIG. 4) of the device 1. These ropes 10 pass each other in opposite directions at the point where the locking handle 13 together with the bail 15 locks both ropes 10 against an underlying rough surface 17. This rough surface 17 is in its turn recessed into the housing 30 because the ropes 10 that are passing each other are not to be braked by the rough surface 17 when the locking handle 13 is open. The device 1 has elongated mounting openings 3 which may be used when fitting it to the side of the ladder upright 6 of a ladder 20. The ropes 10 are threaded through the guiding holes 5 of the device 1 before they can be pulled further up and down along the ladder upright 6.

FIGS. 3 and 4 show a device 1, with (FIG. 3) and without (FIG. 4) a locking handle 13, respectively. The device 1 has elongated mounting openings 3 which can be used when the device 1 is fitted to the side of the ladder upright 6 of a ladder 20. The device 1 can be attached through the elongated mounting openings 3 which are located at the top and at the bottom of the device 1, so that they can be adapted for ladders 20 having different distances between the hollow rungs 21 of the ladder 20. Said elongated mounting openings 3 may be integrated in the device 1 or formed in a fitting fitted thereto. The device 1 may be attached to the ladder 20 by inserting two rods, with stop nuts furthest out and threads at the other ends (not shown), through the elongated mounting openings 3 of the device 1 and into holes 4 extending through the ladder upright 6 and two hollow rungs 21. On the opposite side, two elongated sleeves, with internal threads and stop nuts furthest out (not shown), may be inserted into the holes 4 of the ladder upright 6 and the hollow rungs 21, possibly through mounting openings 3 in a second device 1 on the other side of the ladder 6. Sleeves may be screwed into threads on said rods inside the rungs 21. With this fitting method, the device 1 can be adapted for different widths of ladders 20. The ropes 10 are threaded through the guiding holes 5 of the device 1 before they may be pulled further up and down along the ladder upright 6 and may be threaded through one of the uppermost and one of the lowermost holes 4 of ladder rungs 21. If a device 1 fitted to both ladder uprights 6, ropes 10 from the second device 1 can be run through holes 4 in other ladder rungs 21 so that no two ropes 10 will be inserted into the same holes 4 in the ladder rungs. The ladder 20 is locked in position by using the locking handles 13 of the device 1. The ropes 10 are locked by a resilient bail 15 being depressed towards the ropes 10 coming out of two holes 16 in the device 1. FIG. 4 shows the most clearly how the two ropes 10 come out of respective holes 16 and intersect over the rough surface 17.

FIG. 5 shows a ladder 20 with devices 1 fitted to the outer sides of the ladder uprights 6 of the ladder 20. The ropes 10 run from the devices 1 up and down along the ladder uprights 6 and through the holes 4 of two of the lowermost and two of the uppermost hollow rungs 21. Both ends of the ropes 10 are then attached to snap hooks 8 on each side of the ladder uprights 6 of the ladder 20. The devices 1 are attached at an accessible height, whereby they may be locked and the ladder 20 stabilized before the ladder 20 is stepped onto. The device 1 is fitted to the ladder 20 through a hollow ladder rung 21. This is a different fitting method from that shown in FIGS. 1-4.

FIG. 6 shows the ladder 20 of FIG. 6 put up against a wall and stabilized by the ropes 10 on each side of the ladder uprights 6 of the ladder 20 having been pulled out from the ladder 20 in V-shapes away from the ladder 20. The ropes 10 with ring terminations 7 are attached to snap hooks 8 which are hooked, on one side of the ladder 20, into an eye bolt 9 mounted to the wall and, on the other side, into a suction cup 11 stuck to a window 12. The devices 1 include two rope reels 2 which are lockable by means of a locking handle 13. This means that the ladder 20 cannot fall forwards, backwards or to the sides. With the use of the device 1 for stabilization, there is therefore no need for an extra person standing at the bottom of the ladder as a counterweight and stabilizer, and the ladder 20 can be stabilized before the rung of the ladder 20 is stepped onto for the first time. The means required for making said device 1 can be dimensioned in relation to the weight of the ladder and user, or be made on the basis of different standard ladders and dimensioned in relation to an average weight of a person plus a good margin of safety. When the ladder 20 is being moved laterally, the locking handle 13 is opened and the device 1 with two reels 2 on one side will reel the ropes 10 in while, at the same time, the other device 1 with two reels 2 on the other side will pay the ropes 10 out. This makes the rope 10 always tight. The two reels 2 of each device 1 work independently of each other, so that if one reel 2 is in need of more or less rope 10, this does not affect the other reel 2.

FIG. 7 shows, viewed from the side, a stabilized extension ladder 20 which has been put up against a house wall. The devices 1 and ropes 10 have been fitted to the bottom part of the ladder 20. The ladder 20 is secured with ropes 10 out from the ladder to eye bolts 9 mounted to a wall. Any anchor can be used for hooking snap hooks 8 with ropes 10 into. The rope 10 with snap hooks 8 can be secured to walls, around poles, around corners, to masonry walls et cetera. Carrier suction cups 11, which are used for lifting glass, can be used as anchors on windows 12 and smooth surfaces (as in FIG. 2). As an anchor 9 on a wall, tie-down straps with grommets or the like can also be mounted, around all or parts of the building.

FIG. 8 shows, viewed from above, a ladder 20 with two devices 1 and also a longitudinal locking bail 18 fitted thereto and attached to the opening and locking handles 13 of both rope drums 2. The locking bail 18, which is attached along the ladder rung 21, will then operate the locking mechanisms of both devices 1 simultaneously. This locking bail 18 is attached to openings 19 in the locking handles 13 (see FIG. 3). The locking bail 18 is adjustable to be adaptable to ladders 20 of different widths. When a user steps onto the ladder 20, he/she will depress said locking bail 18, and all four ropes 10 from the two devices 1 will be locked simultaneously. Thereby the ladder 20 is locked in the desired position to the wall.

FIG. 9 shows a ladder 20 with devices 1 fitted to the outer sides of the ladder uprights 6 of the ladder 20. The ropes 10 run from the devices 1, up and down along the ladder uprights 6 and through the holes in eye bolts 22 at both end portions of both ladder uprights 6. Both ends of the ropes 10 are then attached to snap hooks 8 on each side of the ladder uprights 6 of the ladder 20. The devices 1 are attached at an accessible height, whereby they can be locked and the ladder 20 stabilized before the ladder 20 is stepped onto. The device 1 is fitted to the ladder 20 through a hollow ladder rung 21. This embodiment is also suitable for ladders 20 that do not have hollow rungs 21.

FIG. 10 shows a ladder 20 with two devices 1 fitted to one ladder upright 6 in the same housing. These two devices 1 may be regarded as a double device 23 with four reels 2. The double device 23 has a locking handle 13 which locks all four reels 2. The ropes 10 from one device 1 have been run along the ladder upright 6 to each end portion of the ladder 20 and through respective hollow rungs 21 to the other side of the ladder 20, where the ends 7 of the ropes 10 are attached to a snap hook 8. The ropes 10 from the other device 1 have been run along the same ladder upright 6 to each end portion of the ladder 20 and through respective eye bolts 22 mounted to the ladder 20, after which the ends 7 of the ropes 10 are attached to a snap hook 8. Thereby both end portions of both ladder uprights 6 can be secured against falls.

FIG. 11 shows a second embodiment of the device 1 according to the invention. This embodiment is adapted for using reels 2 with belts, but the belts have been left out in the drawings for the sake of simplicity. The device 1 includes two reels 2 and a locking handle 13 for locking both belts of the device 1.

FIG. 12 shows the side of the device 1 that faces the ladder upright 6. Here, a lip 26 and a displaceable mounting bracket 27 are placed, arranged to be attached to each side of the ladder upright 6 when the device 1 is to be fitted. The device 1 is then tightened via the mounting opening 25. The mounting opening 25 is elongated, to be adaptable to ladders with different distances between the hole of the ladder rung 21 and the edges of the ladder upright 6.

The locking mechanism, which is shown on a larger scale in FIGS. 13 and 14, includes a toe 24 connected to the locking handle 13, a resilient part 15 and two parallel rough surfaces 17, between which there is space for two belts side by side to move when the locking mechanism is in the open state (FIG. 13). When the locking handle 13 is rotated, the toe 24 is rotated and presses on the resilient part 15, whereby the two rough surfaces 17 are pressed against each other (FIG. 14). Thereby the two belts are clamped between the two rough surfaces 17. This locking mechanism may also lock more belts, if more reels are placed next to each other.

FIG. 15 shows a similar locking mechanism, but with four rough surfaces 17 forming two gaps in two layers for belts. Thereby, for example, four belts may be locked in two layers. A control knob 28 ensures that both gaps are open when the locking mechanism is open, while it may be moved up into the resilient part 15 when the locking mechanism is locked.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. A device for securing a ladder against falling to one side, the device comprising:
a first reel and a second reel, the first reel including a first elongated, flexible connecting means arranged to be run to an anchor via one end portion of the ladder, and the second reel including a second elongated, flexible connecting means arranged to be run to an anchor via the second end portion of the ladder;
a locking mechanism for locking the elongated flexible connecting means;
wherein the device is mountable on the ladder in such a way that, in a position of use, the locking mechanism is accessible from one end portion of the ladder.

2. The device according to claim 1, wherein the device further comprises a housing accommodating both reels.

3. The device according to claim 1, wherein the elongated, flexible connecting means include free ends arranged to be attached to an anchor.

4. The device according to claim 1, wherein the locking mechanism includes a resilient part and a rough surface, the resilient part being adapted for locking both elongated, flexible connecting means by fixingly pressing them against the rough surface.

5. The device according to claim 1, wherein the locking mechanism includes a locking bail mountable along a ladder rung.

6. A ladder on which at least one device has been fitted, the device comprising:
a first reel and a second reel, the first reel including a first elongated, flexible connecting means arranged to be run to an anchor via one end portion of the ladder, and the second reel including a second elongated, flexible connecting means arranged to be run to an anchor via the second end portion of the ladder;
a locking mechanism for locking the elongated flexible connecting means;
wherein the device is mountable on the ladder in such a way that, in a position of use, the locking mechanism is accessible from one end portion of the ladder.

7. The ladder according to claim 6, wherein the at least one device has been fitted in such a way that the locking mechanism is accessible from one end portion of the ladder.

8. The ladder according to claim 6, wherein the ladder includes hollow rungs, and wherein the first, elongated, flexible connecting means has been run along one ladder upright of the ladder and through a hollow rung in one end portion of the ladder, and wherein the second elongated, flexible connecting means has been run along the ladder upright and through a hollow rung in the other end portion of the ladder.

9. The ladder according to claim 8, wherein the ladder includes a device according to on each ladder upright, each device comprising:
the first reel and the second reel, the first reel including the first elongated, flexible connecting means arranged to be run to an anchor via one end portion of the ladder, and the second reel including the second elongated, flexible connecting means arranged to be run to an anchor via the second end portion of the ladder;
the locking mechanism for locking the elongated flexible connecting means;
wherein each device is mountable on the ladder in such a way that, in a position of use, the locking mechanism is accessible from the one end portion of the ladder, and wherein the elongated, flexible connecting means from each device has been threaded through a respective hollow rung.

10. A system for stabilizing a ladder, the system including a ladder on which at least one device has been fitted, the device comprising:
a first reel and a second reel, the first reel including a first elongated, flexible connecting means arranged to be run to an anchor via one end portion of the ladder, and the second reel including a second elongated, flexible connecting means arranged to be run to an anchor via the second end portion of the ladder;
a locking mechanism for locking the elongated flexible connecting means;
wherein the device is mountable on the ladder in such a way that, in a position of use, the locking mechanism is accessible from one end portion of the ladder, and wherein the system further including anchoring devices which can be secured to a surface and which can receive the ends of the elongated, flexible connecting means.

11. A method of securing a ladder on which at least one device has been fitted, the device comprising:
a first reel and a second reel, the first reel including a first elongated, flexible connecting means arranged to be run to an anchor via one end portion of the ladder, and the second reel including a second elongated, flexible connecting means arranged to be run to an anchor via the second end portion of the ladder;
a locking mechanism for locking the elongated flexible connecting means;
wherein the device is mountable on the ladder in such a way that, in a position of use, the locking mechanism is accessible from one end portion of the ladder against falling to one side, wherein the method comprises:
pulling the elongated, flexible connecting means out from the reels;
securing the elongated, flexible connecting means to an anchor away from the ladder; and
locking the elongated, flexible connecting means by means of the locking mechanism.

12. A device for securing a ladder against falling to one side, the device being arranged to let out two elongated, flexible connecting means and lock them, and the device being mountable on a ladder.
